(19) United States
(12) Patent Application Publication
(10) Pub. No.: US 2015/0087242 A1
(43) Pub. Date: Mar. 26, 2015

(54) SYSTEMS AND METHODS FOR ACTIVE CELLULAR TRANSCEIVER ANALYSIS FOR HARMFUL PASSIVE INTERMODULATION DETECTION

(71) Applicant: Fluke Corporation, Everett, WA (US)

(72) Inventors: Douglas Bain, Braselton, GA (US); Randy Fischer, Flowery Branch, GA (US); Alan B. Lowell, Duluth, GA (US); Wonoh Kim, Johns Greek, GA (US)

(73) Assignee: Fluke Corporation, Everett, WA (US)

(21) Appl. No.: 14/037,739

(22) Filed: Sep. 26, 2013

(51) Int. Cl. H04B 17/00; H04B 1/40

(52) U.S. Cl. CPC H04B 17/0097; H04B 1/40
USPC 455/73

(57) ABSTRACT

Described herein is a system and method for detecting intermodulation distortion (IMD), such as passive intermodulation (PIM) signals, that are being generated by an active cellular transceiver. One such system may include a diagnostic module that detects signals emitted by an active cellular transceiver that has at least two active signals. The detected frequencies of the active signals are compared against potential PIM frequencies to identify potential PIM signals, and the results of this comparison will be analyzed statistically to generate a confidence value in the identification of potential PIM signals.

### FIELD OF THE INVENTION

The present invention relates to acquiring detecting radio frequency signal interference, and more particularly to detecting passive intermodulation (PIM) in an active cellular transceiver.

### BACKGROUND OF THE INVENTION

As the use of cellular phones has increased, the likelihood of signal interference has also increased. One cause of signal interference is intermodulation distortion (IMD), such as passive intermodulation (PIM). PIM signals can be generated by a non-linear mixing of two or more signals. When PIM signals are generated, they can cause interference on the signals at neighboring frequencies, and even other signals out of band.

The current approach to test for PIM has been to deactivate a cellular transceiver, connect a signal generation and measurement device, and test if PIM signals are generated by the two or more test signals. However, a problem with this approach is that it requires deactivating all or part of a cellular transceiver. Accordingly, there is an unmet need for methods and systems of testing for PIM signals generated by an active cellular transceiver.

### SUMMARY OF THE INVENTION

The purpose and advantages of the below described illustrated embodiments will be set forth in and apparent from the description that follows. Additional advantages of the illustrated embodiments will be realized and attained by the devices, systems, and methods particularly pointed out in the written description and the claims herein, as well as from the drawings.

To achieve these and other advantages, and in accordance with the illustrated embodiments, in one aspect, is a system and method for detecting passive intermodulation (PIM) signals being generated by an active cellular transceiver. An exemplary system includes an analysis unit such as a diagnostic module that detects a set of transmit signals emitted by an active cellular transceiver, the signals including a first and second active signal. The frequencies of these signals are written to a log file, which is then read and analyzed to attempt to identify PIM signals. The frequencies of the active signals are utilized to calculate second-order PIM signal frequencies, third-order PIM signal frequencies, fourth-order PIM signal frequencies, and fifth-order PIM signal frequencies; however, it is recognized herein that only one or more of the potential PIM frequencies may be calculated. These calculated prospective PIM signal frequencies are compared to the detected frequencies. If there is a match, this result is logged. A match will be compared to later matches via statistical analysis to determine a correlation, and thus, confirmation of PIM signals.

### BRIEF DESCRIPTION OF THE DRAWINGS

So that those having ordinary skill in the art, to which the present invention pertains, will more readily understand how to employ the novel system and methods of the present invention, certain illustrated embodiments thereof will be described in detail herein-below with reference to the drawings, wherein:

FIG. 1A illustrates a system diagram of an exemplary embodiment of diagnostic module for detecting PIM signals from an active cellular transceiver;

FIG. 1B illustrates a system diagram of another exemplary embodiment of diagnostic module for detecting PIM signals from an active cellular transceiver;

FIG. 2 is a flow chart illustrating an exemplary use of the embodiment of FIGS. 1A and 1B; and

FIG. 3 is an illustration of an embodiment of a computing device.

### DETAILED DESCRIPTION OF CERTAIN EMBODIMENTS

The below illustrated embodiments are directed to management system and method for detecting passive intermodulation (PIM) signals from an active transceiver in which a component or a feature that is common to more than one illustration is indicated with a common reference. It is to be appreciated the below illustrated embodiments are not limited in any way to what is shown, as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the certain illustrated embodiments. Also, the flow charts described herein do not imply a required order to the steps, and the illustrated embodiments and processes may be implemented in any order that is practicable.

Unless defined otherwise, all technical and scientific terms used herein have the same meaning as commonly understood by one of ordinary skill in the art relating to the below illustrated embodiments. Although any methods and materials similar or equivalent to those described herein can also be used in the practice or testing of the below illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the certain embodiments described herein are preferably utilized in conjunction with a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the certain embodiments described herein. Thus the certain embodiments are not to be understood to be limited by what has been particularly shown and described, except as indicated by the appended claims.

The methods described herein allow users to, in an exemplary use, detect intermodulation distortion (IMD), such as passive intermodulation (PIM) that is produced by passive elements. Initially, two active cellular communication signals are detected, a first active signal and a second active signal. The first and second active signals each have a frequency. The frequency may be discovered by reading data from a log file. Alternatively, the frequency may be discovered by the device detecting the first and second active signals.

After the frequency of the active signals is detected, a diagnostic module calculates potential PIM frequencies that may be generated by the active signals. This calculation may include calculating second-order PIM signals, third-order PIM signals, fourth-order PIM signals, and fifth-order PIM signals.

The list of potential PIM frequencies is compared against the frequency of the detected signals. The frequencies of the detected signals are preferably read from a log file. Alternatively, the frequencies of the detected signals may be discovered by the device detecting the transmitted signals.

If the comparison of potential PIM frequencies matches the detected frequencies, then the diagnostic module stores the information in a database and/or communicates the information. Further, the diagnostic module may store the match, and at a later point, when further matches have been detected, compare the match to other matches. In this way, statistical analysis can be used to determine a confidence factor for one or more detected PIM signals. In this exemplary use, the diagnostic module may verify the detection of a PIM signal after the confidence factor is satisfied (e.g., 95% confidence that a PIM signal has been detected).

The monitoring of the active cellular transceiver may be done for extended and continuous periods of time. Alternatively the monitoring may be done for various periods of time, such as, for exemplary purposes only and without limitation, one hour per day in the middle of the night during less cellular traffic, one hour per day in the middle of the day during increased cellular traffic, or any period of time, repeating on a daily or hourly basis, or other permutations as known and recognized by those skilled in the art.

In another embodiment, after signals are detected, the diagnostic module detects and/or stores the frequencies of the detected signals. Two signals are selected, and the difference in their frequencies is calculated, Δf. The two signals are identified as the higher frequency signal and the lower frequency signal. Δf is added to the higher frequency signal, and Δf is subtracted from the lower frequency signal, resulting in first-order resultant frequencies. If either first-order resultant frequency is consistent with the frequency of a detected frequency, then a match is registered.

At this point the diagnostic module may store the match in a database, or communicate the match of one or more detected PIM signals. Alternatively, the diagnostic module may look for a second-order match. In one embodiment, this includes conducting the same math on the signal frequencies as before (i.e., add Δf to the higher of the first-order resultant frequencies, and subtract Δf from the lower of the first-order resultant frequencies); this produces four second-order resultant frequencies (2f1, 2f2, f1+f2, |f1−f2|). If either second-order resultant frequency is consistent with the frequency of a detected frequency, then (another) match is registered.

For an example, signals are detected at 900, 905, 910, and 932 MHz. The diagnostic module selects the 900 and 905 MHz signals for analysis. It calculates the first-order resultant frequencies, which in this example would be 895 and 910 MHz. Because the higher first-order resultant frequency is consistent with a detected frequency, a match is registered. The existence of this match may indicate a PIM signal, or it may simply indicate the possibility of a PIM signal. Of the three relevant considered signals, i.e., 900, 905, and 910, the 900 and 910 signals appear to have the strongest possibility of being a PIM signal (the 900 MHz signal because it may be a third-order PIM signal created by active signals 905 and 910, and the 910 MHz signal because it may be a third-order PIM signal created by active signals 900 and 905).

In another example, signals are detected at 900, 905, 910, 915, and 952 MHz. The diagnostic module selects the 910 and 952 MHz signals for analysis. It calculates the first-order resultant frequencies, which in this example would be 868 and 994 MHz. Because neither frequency is consistent with a detected frequency, no match is registered.

Continuing this example, the diagnostic module may next select the 900 and 905 MHz signals, or the diagnostic module may have originally selected the 900 and 905 MHz signals. The first-order resultant signals generate a match at 910 MHz, so a match is registered for the first-order resultant signals. The second-order resultant signals also generate a match at 915 MHz. Further, because the second-order resultant signal (i.e., 915 MHz) was generated from a first-order resultant signal that also generated a match (i.e., 910 MHz), corresponding matches have been generated by the first-order and second-order resultant signals. Accordingly, the diagnostic module may store the matches and make note of the fact that they correspond to each other, or the diagnostic module may communicate the matches and the fact of their correspondence. Alternatively, the diagnostic module may compare the four relevant signals (i.e., 900, 905, 910, and 915 MHz) against known frequencies of active cellular communications, these frequencies having been read from a log file, detected, and/or communicated to the diagnostic module.

Still continuing this example when the signals are detected at 900, 905, 910, 915, and 952 MHz, the diagnostic module may select the 905 and 910 MHz signals for analysis. It calculates the first-order resultant frequencies, which in this example would be 900 and 915 MHz. Both first-order resultant frequencies are consistent with a detected frequency, so two matches are registered. Thus, the two first-order resultant frequencies generate corresponding matches. Accordingly, the diagnostic module may store the matches and make note of the fact that they correspond to each other, or the diagnostic module may communicate the matches and the fact of their correspondence. Alternatively, the diagnostic module may compare the four relevant signals (i.e., 900, 905, 910, and 915 MHz) against known frequencies of active cellular communications, these frequencies having been read from a log file, detected, and/or communicated to the diagnostic module.

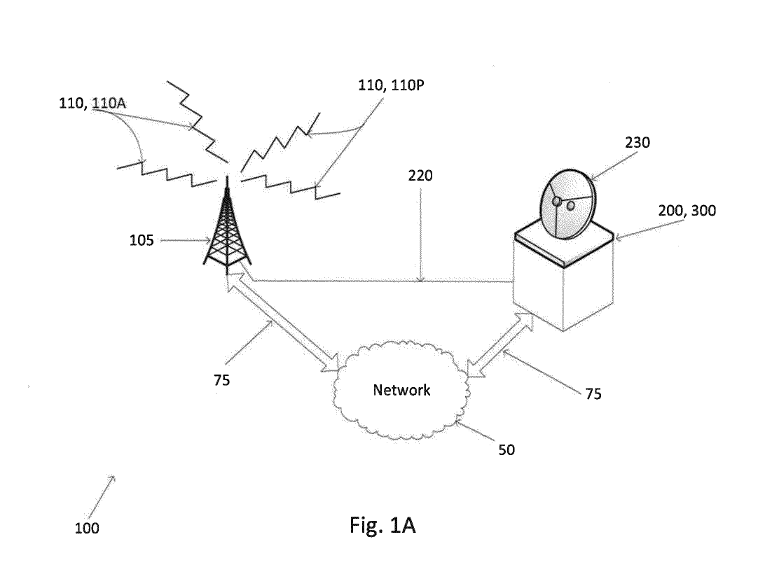

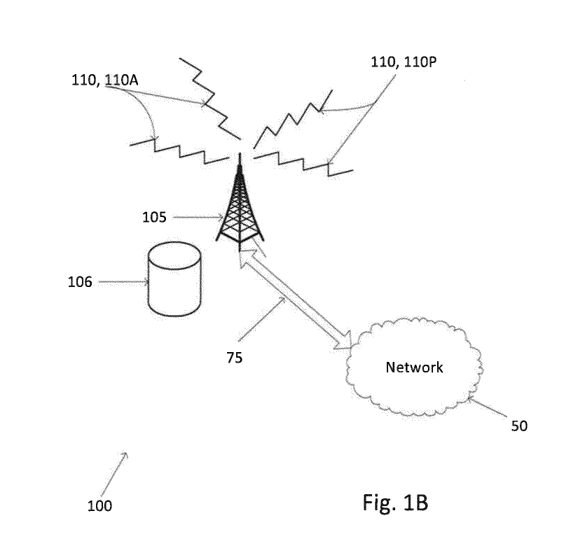

Referring to FIG. 1, a hardware diagram depicting a system 100 in which the processes described herein can be executed is provided for exemplary purposes. In one embodiment, system 100 includes diagnostic module 200 that includes receiver 230 and wire 220 that communicatively connects diagnostic module 200 to transceiver 105. Transceiver 105 is emitting signals 110, which include two active cellular communication signals 110A and a PIM signal 110P.

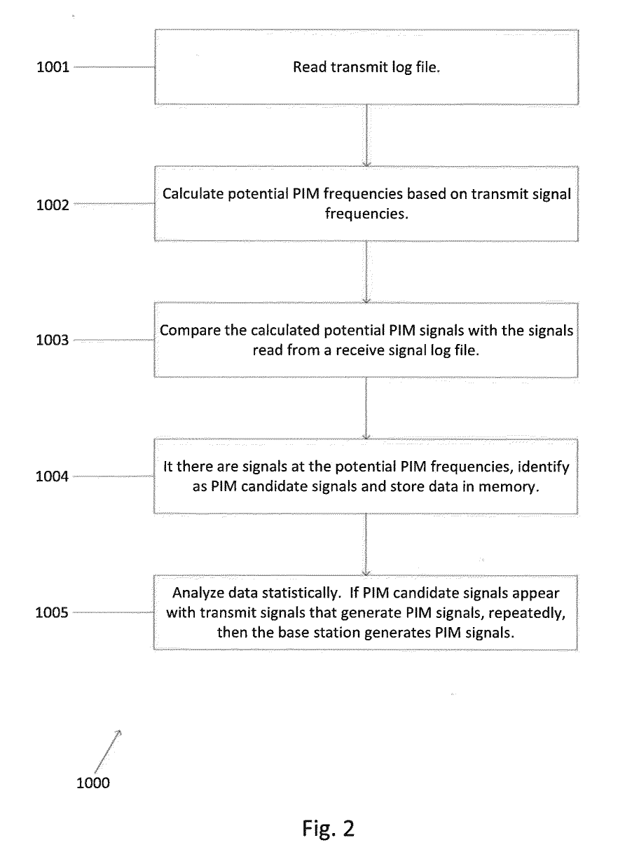

Turning to FIG. 2, illustrated therein is an exemplary process 1000 of utilizing system 100. In one exemplary use, starting at step 1001, signals 110 are detected at receiver 230. Signals 110 include a first and second active signal 110A, as well as additional signals 110 that are PIM signals 110P. The frequencies of active signals 110A may be read from a log file 106 (step 1001). The log file may include a transmit log file that includes information about active signals as well as a receive log file that includes information about signals that have been received. However, it is contemplated herein that the frequency of active signals 110A may be determined by, and communicated from, receiver 230 detecting active signals 110A.

Diagnostic module 200 analyzes the plurality of signals 110 to determine if PIM signal 110P exists. Diagnostic module 200 also calculates potential PIM frequencies (step 1002). This may include calculating potential second-order PIM signal frequencies, potential third-order PIM signal frequencies, potential fourth-order PIM signal frequencies and potential fifth-order PIM signal frequencies.

For illustrative purposes only, and without limitation, two active cellular communication signals are being transmitted at frequencies of 900 MHz (first active signal, f1) and 910 MHz (second active signal frequency, f2). If they generate intermodulation (IMD), such as passive intermodulation (PIM), they may cause interference to other signals.

Second-order PIM frequency signals result from a combination of exactly two instances of signals. For example, the frequencies of f1 (900 MHz) and f2 (910 MHz) could additively combine, to produce a signal at 1,810 MHz. The frequency of f1 could be subtractively taken from f2, to produce a signal at 10 MHz, or each signal could additively combine with itself, to produce signals at 1,800 MHz (two first signals) and 1,820 MHz (two second signals). The 10 MHz, 1800, 1810, and 1820 PIM signal frequencies are sometimes referred to as “out of band”, because their frequency is relatively far from the origin signal frequencies.

Third-order PIM frequency signals result from a combination of exactly three instances of signals, such as two instances of f1 and one instance of f2. More particularly, and continuing the same example using original signals 900 MHz (f1) and 910 MHz (f2), third-order PIM frequencies may be produced via:

f1; (1)

f2; (2)

3*f1; (3)

3*f2; (4)

2*f1+f2; (5)

|2*f1−f2|; (6)

2*f2+f1; and (7)

|2*f2−f1|. (8)

The frequencies produced would be (1) 900, (2) 910, (3) 2,700, (4) 2,730, (5) 2,710, (6) 890, (7) 2,720, and (8) 920. In particular, (6) 890 MHz and (8) 920 MHz can be troublesome for the origin signal frequencies of 900 MHz and 910 MHz because the frequencies are so close. As mentioned above, the other six third-order PIM frequencies are sometimes referred to as “out of band”, because their frequency is so different than the origin signal frequencies.

Fifth-order PIM frequency signals result from a combination of exactly five instances of signals, such as three instances of f1 and two instances of f2. More particularly, and continuing the same example using original signals 900 MHz (f1) and 910 MHz (f2), fifth-order PIM frequencies that are not out-of-band may be produced by (1) |3*f1−2*f2| and (2) |3*f2−2*f1|, which results in (1) 880 MHz and (2) 930 MHz. These “in band” fifth-order PIM signal frequencies may be troublesome for the origin signal frequencies.

Generally speaking, although not necessarily, third-order PIM “in band” signals (i.e., frequencies at 890 MHz and 930 MHz in the above example) are of the most concern because they are close to the origin signals and difficult to remove by filtering, although fifth-order PIM signals, and sometimes seventh-order and ninth-order PIM signals, can also be troublesome.

The calculated prospective PIM signals (e.g., second-order PIM signals, third-order PIM signals, and fifth-order PIM signals) are compared against the detected signals, and PIM signals are identified (step 1003). This may include comparing prospective PIM signals against known frequencies of active signals. If there are signals at the potential PIM frequencies, these signals are identified as PIM candidate signals (step 1004). Finally, the data is analyzed statistically such that if PIM candidate signals appear with transmit signals that generate PIM signals, and the PIM signals are detected a plurality of times, then the base station generates PIM signals.

In another exemplary use, and with reference to FIG. 2, starting at step 1001, signals 110 are detected at diagnostic module via receiver 230. Signals 110 include a first and second active signal 110A, as well as additional signals 110 that are received that are PIM signals 110P. The frequencies of active signals 110A are preferably read from a log file (step 1001). However, it is contemplated herein that the frequency of active signals 110A may be determined by, and communicated from, receiver 230 detecting active signals 110A.

For illustrative purposes only, suppose four signals are detected at frequencies of 900, 905, 910, and 922. Two signals are selected, and the difference in their frequency is calculated, Δf. For example, if signal frequencies 900 and 905 are selected, then two signals are selected, and the difference in their frequency is calculated, Δf becomes 5. The difference in frequency, Δf, is added to the higher selected frequency (905 in this example), and subtracted from the lower selected frequency (900 in this example), producing 895 MHz and 910 MHz. These are first-order resultant frequencies of the selected frequencies. The first-order resultant frequencies are compared against the frequencies of the other signals (in this example, 910 and 922). Because the frequency of 910 is found in both the detected signals and the first-order resultant frequencies, there is a corresponding match.

Further, the second-order resultant frequencies are calculated by adding Δf to the higher first-order resultant frequency and subtracting Δf from the lower second-order resultant frequency, producing 890 and 915. In this example, there is no corresponding match between the second-order resultant frequency and the detected frequencies (it is once again noted, that the frequency of “detected frequencies” may also be read from a log file).

After a corresponding match is identified, the correspondence may be communicated as an indication of a detected PIM signal. Alternatively, the corresponding match is stored, such as in a log file or in a database, and later, if and/or when another corresponding match is identified, the two or more corresponding matches may be compared and/or contrasted. In this way, statistical analysis may assist a determination of whether a PIM signal has been detected.

In the embodiment in FIG. 1, wire 220 communicatively connects transceiver 105 to diagnostic module 200. However, it is contemplated herein that diagnostic module 200 may receive information about the frequency of active signals 110A via any means known in the art, including without limitation, via a log file, the log file being located within diagnostic module 200, transceiver 105, or any other location that may be accessible by diagnostic module 200. Further, it is contemplated herein that transceiver 105 may communicate with diagnostic module 200 via communications 75 over network 50, network 50 being any network, internet, intranet, and/or combination thereof as known in the art.

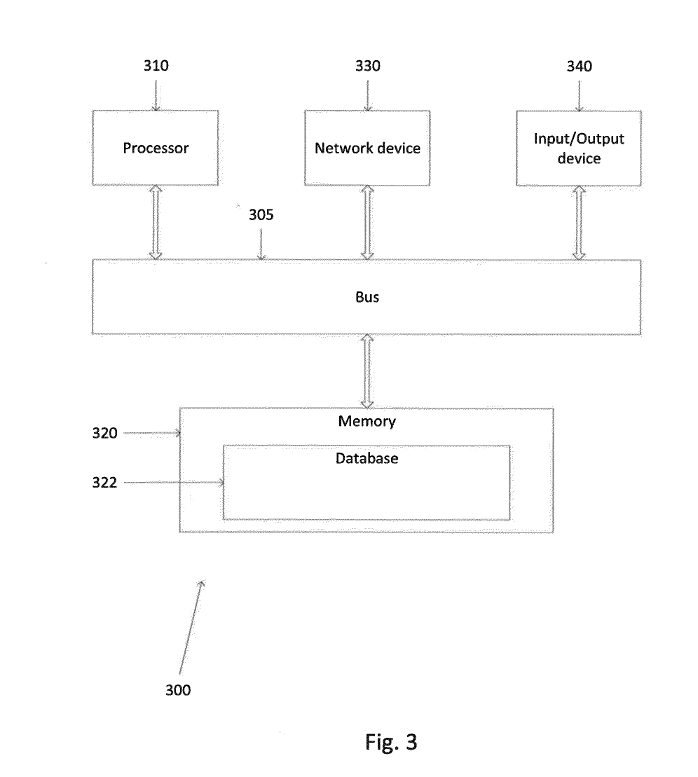

Diagnostic module 200 preferably includes computing device, and the components thereof. For example, in FIG. 1, diagnostic module 200 may be any computing device 300 (FIG. 3) such as, for exemplary purposes only, desktop, a tablet, or a laptop.

The term “module”/“engine” is used herein to denote a functional operation that may be embodied either as a stand-alone component or as an integrated configuration of a plurality of subordinate components. Thus, diagnostic module 200 may be implemented as a single module or as a plurality of modules that operate in cooperation with one another. Moreover, although diagnostic module 200 is described herein as being implemented as software, it could be implemented in any of hardware (e.g. electronic circuitry), firmware, software, or a combination thereof.

With reference now to FIG. 3, memory 320 is a computer-readable medium encoded with a computer program. Memory 320 stores data and instructions that are readable and executable by processor 310 for controlling the operation of processor 310. Memory 320 may be implemented in random access memory (RAM), non-transitory tangible computer-readable memory, volatile or non-volatile memory, solid state storage devices, magnetic devices, hard drive, a read only memory (ROM), or a combination thereof.

Processor 310 is an electronic device configured of logic circuitry that responds to and executes instructions. Instructions may be read from non-transitory computer-readable memory. Processor 310 outputs results of an execution of the methods described herein. Alternatively, processor 310 could direct the output to a remote device (not shown) via network 50.

It is to be further appreciated that the network environment depicted in FIG. 1 can include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as storage medium. It is to be appreciated that the illustrated network connections of FIG. 1 are exemplary and other means of establishing a communications link between multiple computers may be used.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention as defined by the appended claims.

What is claimed is:

1. A computer-implemented method for detecting passive intermodulation (PIM) on an active cellular transceiver transmission system, comprising the steps of:
detecting, at an analysis unit comprising memory and a processor, a plurality of transmit signals emitted by an active cellular transceiver, wherein at least two of the plurality of transmit signals comprise active cellular communication, the at least two active signals comprising a first active signal and a second active signal;
analyzing the plurality of transmit signals;
calculating potential PIM frequencies; and
identifying PIM signals within the detected plurality of transmit signals at the calculated potential PIM frequencies.

2. The method of 1 further comprising the step of:
reading transmitting and receiving signals data from a log file, the transmitting data comprising transmitting signal frequencies for each of the first active signal and the second active signal, the receiving data comprising receiving signal frequencies for the detected signals.

3. The method of 2, wherein the step of calculating potential PIM frequencies comprises:
calculating at least one of the following potential signal frequencies: (a) second-order PIM signal frequencies that might be caused by the first and second active signals, (b) third-order PIM signal frequencies that might be caused by the first and second active signals, (c) fourth-order PIM signal frequencies that might be caused by the first and second active signals and (d) fifth-order PIM signal frequencies that might be caused by the first and second active signals.

4. A computer-implemented method for detecting passive intermodulation (PIM) on an active cellular transceiver transmission system, comprising the steps of:
detecting, at a diagnostic module comprising memory, a processor and a receiver, a plurality of signals emitted by an active cellular transceiver, wherein at least two of the plurality of signals comprise active cellular communication, the at least two active signals comprising a first active signal and a second active signal;
analyzing the plurality of detected signals; and
identifying a PIM signal within the detected plurality of detected signals.

5. The method of 4, wherein the step of analyzing the plurality of detected signals comprises identifying a frequency for at least two of the plurality of transmit signals, a first detected frequency and a second detected frequency.

6. The method of 5, wherein the first and second active signals each comprise a frequency, the method further comprising the steps of:
calculating a frequency difference between the first and second detected frequencies;
calculating a higher potential frequency by adding the frequency difference to the higher frequency of the first detected frequency and the second detected frequency; and
comparing the higher potential frequency to at least one of the first active signal's frequency and the second active signal's frequency.

7. The method of 6, wherein the first and second active signals each comprise a frequency, the method further comprising the steps of:
calculating a lower potential frequency by subtracting the frequency difference from the lower frequency of the first detected frequency and the second detected frequency; and
comparing the lower potential frequency to at least one of the first active signal's frequency and the second active signal's frequency.

8. The method of 7, further comprising:
storing, in memory, at least one of the frequencies of the first and second detected frequencies.

9. The method of 7, further comprising:
electronically communicating at least one of the frequencies of the first and second detected frequencies.

10. A computer-implemented method for detecting passive intermodulation (PIM) on an active cellular transceiver transmission system, comprising the steps of:
detecting, at a diagnostic module comprising memory and a processor, a plurality of signals emitted by an active cellular transceiver, wherein at least two of the plurality of detected signals comprise active cellular communication, a first active signal and a second active signal;
calculating potential PIM frequencies; and
identifying PIM signals within the plurality of detected signals.

11. The method of 10 further comprising the steps of:
identifying a first active frequency for the first active signal; and
identifying a second active frequency for the second active signal.

12. The method of claim 11, wherein each of the two steps of identifying a frequency for the active signals comprises reading data from a log file.

13. The method of claim 11, wherein each of the two steps of identifying a frequency for the active signals comprises analyzing the first and second active signals.

14. The method of claim 11, wherein the step of calculating potential PIM frequencies comprises calculating at least one third-order PIM signal frequency that might be caused by the first and second active signals, the calculation resulting in at least one third-order calculated frequency.

15. The method of claim 14, wherein the plurality of detected signals consists of the first active signal, the second active signal, and remaining signals, the method further comprising:
comparing the at least one third-order calculated frequency to a frequency of at least one of the remaining signals.

16. The method of claim 15, further comprising:
reading, from a log file, the frequency of at least one of the remaining signals.

17. The method of claim 15, wherein the step of calculating potential PIM frequencies further comprises calculating at least one fifth-order PIM signal frequencies that might be caused by the first and second active signals, the calculation resulting in at least one fifth-order calculated frequency.

18. The method of claim 17 further comprising:
comparing the at least one fifth-order calculated frequency to a frequency of at least one of the remaining signals.

19. The method of claim 18, further comprising:
reading, from a log file, the frequency of at least one of the remaining signals.

20. The method of claim 15, wherein the step of calculating potential PIM frequencies comprises calculating at least one second-order PIM signal frequencies that might be caused by the first and second active signals, the calculation resulting in at least one second-order calculated frequency.
